(19) United States
(12) Patent Application Publication
(10) Pub. No.: US 2021/0262426 A1
(43) Pub. Date: Aug. 26, 2021

(54) DIGITAL INLET VALVE FOR A GASOLINE DIRECT INJECTION SYSTEM OF A MOTOR VEHICLE

(71) Applicants: Hyundai Motor Company, Seoul (KR); Kia Motors Corporation, Seoul (KR)

(72) Inventors: Stephan Revidat, Langen (DE); Alexander Settle, Hainburg (DE)

(21) Appl. No.: 17/003,828

(22) Filed: Aug. 26, 2020

(30) Foreign Application Priority Data
Feb. 26, 2020 (DE) 102020202429.4

(51) Int. Cl. F02M 59/36; F02M 41/14

(52) U.S. Cl. CPC F02M 59/368; F02M 41/1427

(57) ABSTRACT

A digital inlet valve (DIV) for a gasoline direct injection (GDI) system of a motor vehicle is provided. The DIV includes a valve seat that seals a high pressure gasoline chamber of the GDI system against a low pressure gasoline chamber of the GDI system in a closed configuration of the DIV. A valve piston moves the valve seat between the closed configuration and an open configuration of the DIV, in which the high pressure gasoline chamber is in fluid connection with the low pressure gasoline chamber. A valve actuator actuates movement of the valve piston. The valve seat, the valve piston and the valve actuator are separate components, which are selectively plugged into each other.

### CROSS-REFERENCE TO RELATED APPLICATION(S)

This application claims priority to German Patent Application No. 102020202429.4 filed on Feb. 26, 2020, the entire contents of which are incorporated herein by reference.

### BACKGROUND

### Technical field

The present disclosure relates to a digital inlet valve for a gasoline direct injection system of a motor vehicle and a motor vehicle with a gasoline direct injection system having such a digital inlet valve.

### Background Art

In order to fulfill customer's highly sophisticated demands on passenger vehicles and to meet future carbon dioxide (CO₂) emission as well as exhaust gas emission regulation targets, newly developed high efficient gasoline combustion engines often rely on gasoline direct injection (GDI) technology. This technology enables substantial benefits especially for engines with high specific power output and compliant with the up-to-date exhaust gas regulations. The GDI technology generally offers the possibility to reduce the number of assembled components as well as the overall weight.

The fuel supply architecture of modem GDI engines usually delivers gasoline from a fuel tank at low pressure of around 3 to 6 bar by a continuously driven supply pump. The gasoline is then passed to a high pressure pump that pressurizes the gasoline to a pressure of roughly 50 to 500 bar and pumping the gasoline into a rail and from there further to the fuel injectors. The gasoline pressure is regulated by the engine control unit (ECU) of the vehicle via the pumps.

Developed high pressure pumps usually have a digital inlet valve (DIV), which regulates the amount of pressurized fuel that is transferred from low pressure to high pressure in a particular time interval. The DIV mostly utilizes a valve that is electromagnetically actuated and emits sound at a high frequency of roughly 5 to 10 kHz. This usually generates mechanic noise known as “ticking”, which may be perceived as uncomfortable by end-users preferring a smooth driving experience. To reduce these sound emissions, current solutions often rely on significant sound insulation around the high pressure pump potentially leading to additional costs, weight and reduced performance due to fuel heat up.

### SUMMARY

Accordingly, the present disclosure provides a digital inlet valve for a gasoline direct injection system of a motor vehicle and a motor vehicle with a gasoline direct injection system having such a digital inlet valve.

According to one aspect of the present disclosure, a digital inlet valve (DIV) for a gasoline direct injection (GDI) system of a motor vehicle may include a valve seat configured to seal a high pressure gasoline chamber of the GDI system against a low pressure gasoline chamber of the GDI system in a closed configuration of the DIV; a valve piston configured to move the valve seat between the closed configuration and an open configuration of the DIV, in which the high pressure gasoline chamber is in fluid connection with the low pressure gasoline chamber; and a valve actuator configured to actuate movement of the valve piston. The valve seat, the valve piston and the valve actuator are separate components, which are plugged into each other.

According to another aspect of the disclosure, a motor vehicle with a GDI system has a DIV according to the disclosure. The present disclosure is based on the insight that the commonly employed digital inlet valves are provided as integrated and rigid units (e.g. of welded steel) to minimize manufacturing costs and complexity, which however implies that any sound emissions are transferred effectively through the whole unit and are finally emitted to the exterior.

In view of the above, the present disclosure splits up the DIV into several physically separated components, which do not interact with sound as one solid component to prevent sound waves from being transferred through the entire DIV. Instead the parts are merely plugged into each other, thus making the DIV less rigid and providing a natural noise damping effect. The parts hence by construction provide various separate contact points, which function as sound wave barriers. The present disclosure thus decouples the basic functional components of the DIV from each other.

As a result, solid-borne or structure-borne sound emissions may be reduced significantly. In particular, the ticking noise of the valve actuation, which is often considered to be the most significant source of mechanic sound emission in conventional gasoline engines, may be suppressed. Unlike many traditional approaches for sound insulation of the DIV that are mostly based on hydraulic damping techniques, the present approach is insensitive to fuel properties, and thus also involves less engineering efforts and production costs. Moreover, maintenance expenditures may be reduced as the individual functional components may be removed and/or replaced without having to exchange the DIV or even the complete high pressure pump.

Advantageous exemplary embodiments and improvements of the present disclosure are described herein below. According to an exemplary embodiment of the disclosure, the DIV may further include a valve hull that encloses the valve seat around an actuation direction. The valve hull may include a gasoline duct for receiving gasoline from the low pressure gasoline chamber and conducting the gasoline to the valve seat. Thus, the DIV of this exemplary embodiment provides at least four physically separate functional components, including the valve seat, the valve piston, the valve actuator and the valve hull.

According to an exemplary embodiment of the disclosure, the valve hull may be plugged or disposed between the valve piston and the valve seat. Therefore, all four functional components may be plugged together and thus may form a multi-component arrangement of separate elements. According to an exemplary embodiment of the disclosure, the valve seat, the valve piston, the valve actuator and the valve hull may be mounted together in a clamping connection.

Accordingly, one or several clamps or brackets or similar component may be provided that grasp the functional components of the DIV. In principle, it may be sufficient if such a holding device grasps one of the functional components, in particular the outermost component, e.g. the valve actuator. This may automatically fix the further components within a high pressure pump of the GDI system, as these components are plugged-into each other. For example, the valve seat may extend into a corresponding receiving opening of the high pressure gasoline chamber. The valve actuator may be held by a bracket on the other side, which may be attached to an outer housing of the GDI system. The further functional components of the DIV, including the valve piston and the valve hull, may be held in-between the valve actuator on a first side and the valve seat on a second side merely by being plugged together with these components.

According to an exemplary embodiment of the disclosure, the valve actuator may be configured as an electromagnetic linear actuator to actuate movement of the valve piston along the actuation direction. The valve actuator may include a magnetic solenoid for magnetic actuation along an actuation direction. Hence, the DIV may have a configuration that is rotationally symmetric around the actuation direction, that is, the system axis may be arranged along the actuation direction. The valve may be provided in the usual configurations known to those of ordinary skill in the art. For example, the valve may be “normally closed” with de-energized solenoid or “normally open” with energized solenoid.

Additionally, according to an exemplary embodiment of the disclosure, the valve seat, the valve piston, the valve actuator and/or the valve hull may comprise a metal material. For example, some or all of the functional components may be substantially made from a metal, a metal alloy and/or a metal composite material. In one particular example, a light and soft metallic alloy may be used to further enhance sound absorption through the DIV. According to an exemplary embodiment of the disclosure, the DIV may be configured with a resonance frequency below about 5 kHz and/or above 10 kHz.

In other words, the noise of typical GDI pumps has frequencies between roughly 1 kHz and 20 kHz, wherein the digital inlet valve predominantly contributes to the noise between about 5 and 10 kHz. This particular noise range may also be referred to as a “ticking” noise. By decoupling the functional components of the DIV, in particular the valve piston and the valve seat, sound transmission within the ticking range may be effectively decreased. The separation of the functional components may be optimized to minimize sound transmission across the DIV, e.g. by correspondingly arranging the contact points and dividing planes between the individual components. By providing additional damping materials, e.g. rubber layers or soft metallic alloys, noise production within the 5 to 10 kHz range may be further suppressed and practically eliminated. The present disclosure thus omits the need for providing additional damping means like hydraulic damping or similar.

Simulation based comparison between the present solution and standard DIV reveals that the single piece hull of common DIV effectively transmits sound through the complete body of the DIV. Due to weight and stiffness of the commonly used steel material of these valves, the resonance frequency of the entire part may be approximate to the actuation frequency of the DIV. The overall sound or noise for the end-user remains a sum of all sound emitting surfaces. In other words, objects react after stimulation in their resonance frequency. Splitting up the device into the functional subcomponents helps to overcome the above issues by blocking the transfer of solid borne sound at the separating portions of the individual components. The geometric configuration and arrangement of the presently employed functional subcomponents, including the valve seat, the valve piston, the valve actuator and the valve hull, and of their contact areas and/or contact points may be selected such that the resonance frequency of the arrangement is outside of the actuation frequency range of about 5 to 10 kHz. Simulations have confirmed these results by testing from the component's base to the vehicle base.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other exemplary embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a gasoline direct injection system with a digital inlet valve according to an exemplary embodiment of the present disclosure;

FIG. 2 schematically shows a motor vehicle including the gasoline direct injection system of FIG. 1 according to an exemplary embodiment of the present disclosure;

FIG. 3 shows a detailed schematic view of the digital inlet valve of FIG. 1 according to an exemplary embodiment of the present disclosure; and

FIG. 4 shows a detailed view of FIG. 3 according to an exemplary embodiment of the present disclosure.

Although specific exemplary embodiments are illustrated and described herein, it will be appreciated by those of ordinary skill in the art that a variety of alternate and/or equivalent implementations may be substituted for the specific exemplary embodiments shown and described without departing from the scope of the present disclosure. Generally, this application is intended to cover any adaptations or variations of the specific exemplary embodiments discussed herein.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

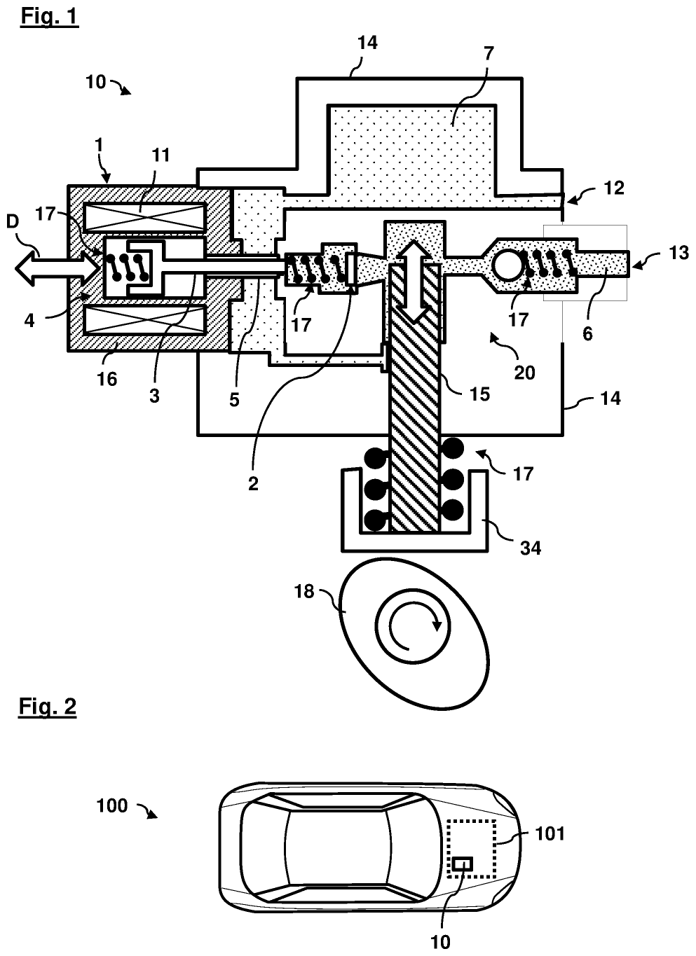

FIG. 1 schematically depicts a gasoline direct injection (GDI) system 10 with a digital inlet valve (DIV) 1 according to an exemplary embodiment of the present disclosure. The GDI system 10 may be integrated into an internal combustion engine 101, in particular an engine running on gasoline, e.g. to power the vehicle depicted in FIG. 2. The various components (e.g., pumps etc. may be operated by a controller)

Since modern vehicles have to meet highest demands concerning consumption, emission and performance standards, gasoline vehicles are mostly equipped with direct fuel injecting systems. Gasoline direct injection indicates that the fuel is injected by an injector directly into a combustion chamber (not depicted) of the engine 101, which then realizes an internal gas mixture. Accordingly, the present system 10 may include a low pressure fuel pump (also not depicted here), configured to pump the gasoline at low pressures (e.g. about 3 bar) via a low pressure gasoline inlet 12 into a low pressure gasoline chamber 7 of the GDI system 10. The digital inlet valve 1 shown in FIG. 1 regulates transfer of the gasoline from the low pressure gasoline chamber 7 to a high pressure gasoline chamber 6 of a high pressure fuel pump 20, from where the gasoline is ejected via a high pressure gasoline outlet 13 into a rail (not depicted) and injected into the combustion chamber of the engine 101.

The high pressure pump 20 may be configured to compress the demanded fuel quantity for the injection to a required pressure level, e.g. about 50 bar up to about 500 bar. Accordingly, the high pressure pump 20 may be driven with a plunger 15 resiliently connected to a tappet 21 via a return spring 17, the tappet 21 in turn being connected to a camshaft 18 of the engine 101. Thus, a pump frequency of the high pressure pump 20 may be driven by the speed of the internal combustion engine 101 (cf. arrow at the plunger 15 in FIG. 1 that indicates an oscillating movement of the plunger 15). The DIV 1 thus has to be actuated at a specific time to deliver an adequate amount of fuel within a predetermined period of time. Accordingly, the DIV 1 may be operated by an engine control unit (ECU) of the engine 101 (not depicted) based on various sensor data.

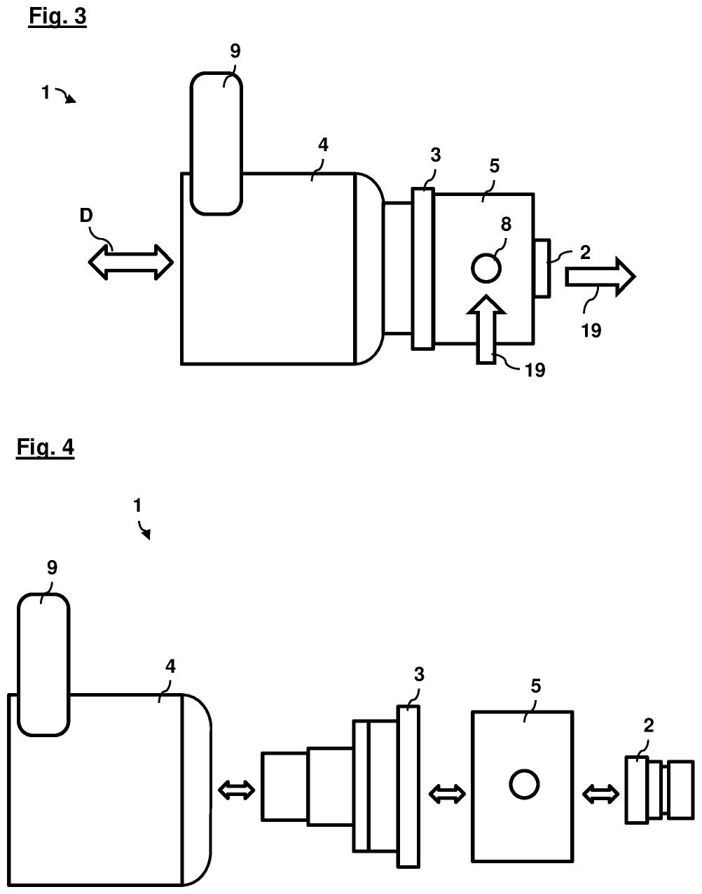

The DIV 1 may be accommodated inside a DIV housing 16 and may include four separate functional components: a valve seat 2, a valve piston 3, a valve actuator 4 and a valve hull 5 (see left side in FIG. 1). The functional components are shown in FIG. 3 in a mounted arrangement and in a detailed view in FIG. 4.

The valve seat 2 may be configured to seal the high pressure gasoline chamber 6 of the GDI system 10 against the low pressure gasoline chamber 7 of the GDI system 10 in a closed configuration of the DIV. The valve piston 3 may be configured to move the valve seat 2 between the closed configuration and an open configuration of the DIV 1, in which the high pressure gasoline chamber 6 is in fluid connection with the low pressure gasoline chamber 7. The valve actuator 4 may operate as an electromagnetic linear actuator powered via electric connection 9 to actuate movement of the valve piston 3 along an actuation direction D. The valve hull 5 may enclose the valve seat 2 around the actuation direction D and may include a gasoline duct 8 for receiving gasoline from the low pressure gasoline chamber 7 and conducting the gasoline to the valve seat 2 (see FIG. 3).

The four functional components, namely the valve seat 2, the valve piston 3, the valve actuator 4 and the valve hull 5, are separate components made from a soft and lightweight metal alloy. In conventional DIV these functional elements are usually provided together as one fully integrated single structural element to save manufacturing costs and simplify the supplier chain. This means that in common DIV the functional elements are rigidly connected within one piece, e.g. by welding several steel components together. In the present disclosure however, four separate components are provided, which are plugged into each other as shown in FIG. 4 and are mounted in a clamping connection, e.g. by a bracket or the like (not depicted). This provision enables significant reduction in sound emissions, as will be described below.

In general, all vibrating surfaces transfer their movement into the air, which in turn generates spherical outspreading waves. These waves have nearly the same frequency as the vibrating body. The resulting sound or acoustic noise is also referred to as solid-borne sound. In simplified conditions, solid-borne sound corresponds to the resonance frequency of the whole body, including its physical boundaries of mass, stiffness and damping.

Vehicle noise emission remains one of the key challenges to meet end-user satisfaction. Powertrain acoustics influences, by positive association, in case of “sportive” sound and negative perception in case for harsh sounds. Studies show that common GDI systems are one major source for mechanic noise emission. Especially in idle condition, this circumstance may be annoying or inconvenient to both driver and pedestrians. Particularly the high pressure pump in modern gasoline direct injection engines may be perceived as acoustically annoying due to a “ticking” noise, which is emitted over the otherwise very smooth operation of these engines. The ticking sound is mainly caused by the rapid closing and opening movement of the digital inlet valve regulating fuel inlet into the high pressure pump.

Studies reveal that GDI system noise covers a range between about 1.6 kHz up 16 kHz. In other words, this range may be split in two major areas for pump function. Pressure generation impacts the area from roughly about 1.6 to 5 kHz, while the digital inlet valve impacts the area from about 5 to 10 kHz. The range of about 5 to 10 kHz may also be described as “ticking” noise.

The underlying principle of the exemplary embodiment of FIGS. 1 to 4 is to decouple all functional elements and provide a dismountable digital inlet valve 1. Therefore, the functional components do not interact as one integrated part, but as smaller parts within the assembly. In other words, the sound emissions of the valve 1 while closing are not transferred through the whole component as solid borne sound. Since the functional components, including the vale seat 2, the valve piston 3, the valve hull 5 and the valve actuator 4, are selectively plugged together (or otherwise connected together in a separable manner), these parts have different contact points, which already inhibits spreading of sound across the DIV 1.

Moreover, since the DIV 1 is less rigid due to the separation of the functional components, a “natural” noise damping effect is established across the assembly. By targeting these effects with additional damping material (e.g. rubber layers, light & soft metallic alloy), the ticking sound emission may be completely suppressed. Accordingly, the material and geometric configuration of the functional components and their different contact and/or fixture points within the assembly may be configured such that the resulting resonance frequencies of the assembly are outside of the ticking range between 5 kHz and 10 kHz. As a consequence, the actuation of the DIV 1 will not lead to solid-borne sound emissions of the DIV 1, since the resonance frequency does not match the actuation frequency.

In particular, the valve seat 2 and the valve piston 3 may be decoupled from each other in the exemplary embodiment of FIGS. 3 and 4, as the valve hull 5 is plugged in-between the valve seat 2 and the valve piston 3 (see FIG. 4 in particular). Since the valve seat 2 and the valve piston 3 are often considered to be the main cause for sound emission during operation of the DIV 1, the present solution thus ensures that no direct connection exists between these components. The present disclosure thus is able to significantly reduce the ticking noise of common digital inlet valves by decoupling the functional elements of the digital inlet valve from each other.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The exemplary embodiments were chosen and described in order to explain the principles of the disclosure and its practical applications, to enable others skilled in the art to utilize the disclosure and various exemplary embodiments with various modifications as are suited to the particular use contemplated.

### REFERENCE LIST

1 digital inlet valve (DIV)
2 valve seat
3 valve piston
4 valve actuator
5 valve hull
6 high pressure gasoline chamber
7 low pressure gasoline chamber
8 gasoline duct
9 electric connection
10 gasoline direct injection (GDI) system
11 magnetic coil
12 low pressure gasoline inlet
13 high pressure gasoline outlet
14 GDI system housing
15 plunger
16 DIV housing
17 return spring
18 engine camshaft
19 gasoline flow
20 high pressure pump
21 tappet
100 motor vehicle
101 internal combustion engine
D actuation direction

What is claimed is:

1. A digital inlet valve (DIV), for a gasoline direct injection (GDI) system of a motor vehicle, comprising:
a valve seat configured to seal a high pressure gasoline chamber of the GDI system against a low pressure gasoline chamber of the GDI system in a closed configuration of the DIV;
a valve piston configured to move the valve seat\between the closed configuration and an open configuration of the DIV, in which the high pressure gasoline chamber is in fluid connection with the low pressure gasoline chamber; and
a valve actuator configured to actuate movement of the valve piston;
wherein the valve seat, the valve piston, and the valve actuator are separate components, which are selectively plugged into each other.

2. The digital inlet valve according to claim 1, further comprising:
a valve hull that encloses the valve seat around an actuation direction,
wherein the valve hull includes a gasoline duct for receiving gasoline from the low pressure gasoline chamber and conducting the gasoline to the valve seat.

3. The digital inlet valve according to claim 2, wherein the valve hull is plugged between the valve piston and the valve seat.

4. The digital inlet valve according to claim 3, wherein the valve seat, the valve piston, the valve actuator, and the valve hull are mounted together in a clamping connection.

5. The digital inlet valve according to claim 1, wherein the valve actuator is configured as an electromagnetic linear actuator to actuate movement of the valve piston along the actuation direction (D).

6. The digital inlet valve according to claim 1, wherein at least one of the valve seat, the valve piston, the valve actuator and the valve hull comprises a metal material.

7. The digital inlet valve according to claim 1, wherein the DIV is configured with a resonance frequency below about 5 kHz or above about 10 kHz.

8. A motor vehicle with a gasoline direct injection (GDI) system having a digital inlet valve (DIV) , wherein the DIV includes:
a valve seat configured to seal a high pressure gasoline chamber of the GDI system against a low pressure gasoline chamber of the GDI system in a closed configuration of the DIV;
a valve piston configured to move the valve seat\between the closed configuration and an open configuration of the DIV, in which the high pressure gasoline chamber is in fluid connection with the low pressure gasoline chamber; and
a valve actuator configured to actuate movement of the valve piston;
wherein the valve seat, the valve piston, and the valve actuator are separate components, which are selectively plugged into each other.

9. The motor vehicle according to claim 8, wherein the DIV further includes:
a valve hull that encloses the valve seat around an actuation direction,
wherein the valve hull includes a gasoline duct for receiving gasoline from the low pressure gasoline chamber and conducting the gasoline to the valve seat.

10. The motor vehicle according to claim 9, wherein the valve hull is plugged between the valve piston and the valve seat.

11. The motor vehicle according to claim 10, wherein the valve seat, the valve piston, the valve actuator, and the valve hull are mounted together in a clamping connection.

12. The motor vehicle according to claim 8, wherein the valve actuator is configured as an electromagnetic linear actuator to actuate movement of the valve piston along the actuation direction (D).

13. The motor vehicle according to claim 8, wherein at least one of the valve seat, the valve piston, the valve actuator and the valve hull comprises a metal material.

14. The motor vehicle according to claim 8, wherein the DIV is configured with a resonance frequency below about 5 kHz or above about 10 kHz.
